(19) United States
(12) Patent Application Publication
(10) Pub. No.: US 2011/0040399 A1
(43) Pub. Date: Feb. 17, 2011

(54) APPARATUS AND METHOD FOR INTEGRATING PLANNING, SCHEDULING, AND CONTROL FOR ENTERPRISE OPTIMIZATION

(75) Inventor: Joseph Z. Lu, Glendale, AZ (US)

Correspondence Address: HONEYWELL/MUNCK;Patent Services, 101 Columbia Road, P.O. Box 2245, Morristown, NJ, 07962-2245, US

(73) Assignee: Honeywell International Inc., Morristown, NJ (US)

(21) Appl. No.: 12/639,740

(22) Filed: Dec. 16, 2009

Related U.S. Application Data
(60) Provisional application No. 61/234,174, filed on Aug. 14, 2009.

(51) Int. Cl. G05B 13/04

(52) U.S. Cl. 700/102; 700/111; 700/104

(57) ABSTRACT

A method includes receiving first input data from one or more first process control system components. The method also includes receiving second input data from one or more second process control system components. In addition, the method includes performing an iterative process that includes identifying one or more adjustments to at least one target quantity using the first input data, identifying one or more contribution values using the one or more adjustments, and identifying one or more estimated product yields using the one or more contribution values and the second input data. Each target quantity is associated with at least one intermediate or final product to be produced. Each contribution value is based on an intermediate product's contribution to each of multiple final products. Each estimated product yield is associated with an expected quantity of one of the intermediate and final products to be produced.

### CROSS-REFERENCE TO RELATED APPLICATIONS

This application claims priority under 35 U.S.C. §119(e) to U.S. Provisional Application No. 61/234,174 filed on Aug. 14, 2009, which is hereby incorporated by reference.

### TECHNICAL FIELD

This disclosure relates generally to enterprise optimization systems. More specifically, this disclosure relates to an apparatus and method for integrating planning, scheduling, and control for enterprise optimization.

### BACKGROUND

Processing facilities are often managed using process control systems. Example processing facilities include manufacturing plants, chemical plants, crude oil refineries, and ore processing plants. Among other operations, process control systems typically manage the use of motors, valves, pumps, and other actuators or industrial equipment in the processing facilities.

Planning and production scheduling for a processing facility typically use aggregate models for longer time horizons. Advanced process control typically uses detailed dynamic models that include many more operating constraints. Often times, numerous operating constraints are omitted from the aggregate models. This typically makes it difficult to perform plant-wide or enterprise-wide optimization in real time since the models used by different components can be substantially different.

### SUMMARY

This disclosure provides an apparatus and method for integrating planning, scheduling, and control for enterprise optimization.

In one example embodiment, a method includes receiving first input data from one or more first process control system components. The method also includes receiving second input data from one or more second process control system components. In addition, the method includes performing an iterative process that includes identifying one or more adjustments to at least one target quantity using the first input data, identifying one or more contribution values using the one or more adjustments, and identifying one or more estimated product yields using the one or more contribution values and the second input data. Each target quantity is associated with at least one intermediate or final product to be produced. Each contribution value is based on an intermediate product's contribution to each of multiple final products. Each estimated product yield is associated with an expected quantity of one of the intermediate and final products to be produced.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example process control system according to this disclosure;

FIG. 2 illustrates an example integration unit according to this disclosure;

FIGS. 3 and 4 illustrate example uses of an integration unit according to this disclosure; and

FIG. 5 illustrates an example method for integrating planning, scheduling, and control for enterprise optimization according to this disclosure.

### DETAILED DESCRIPTION

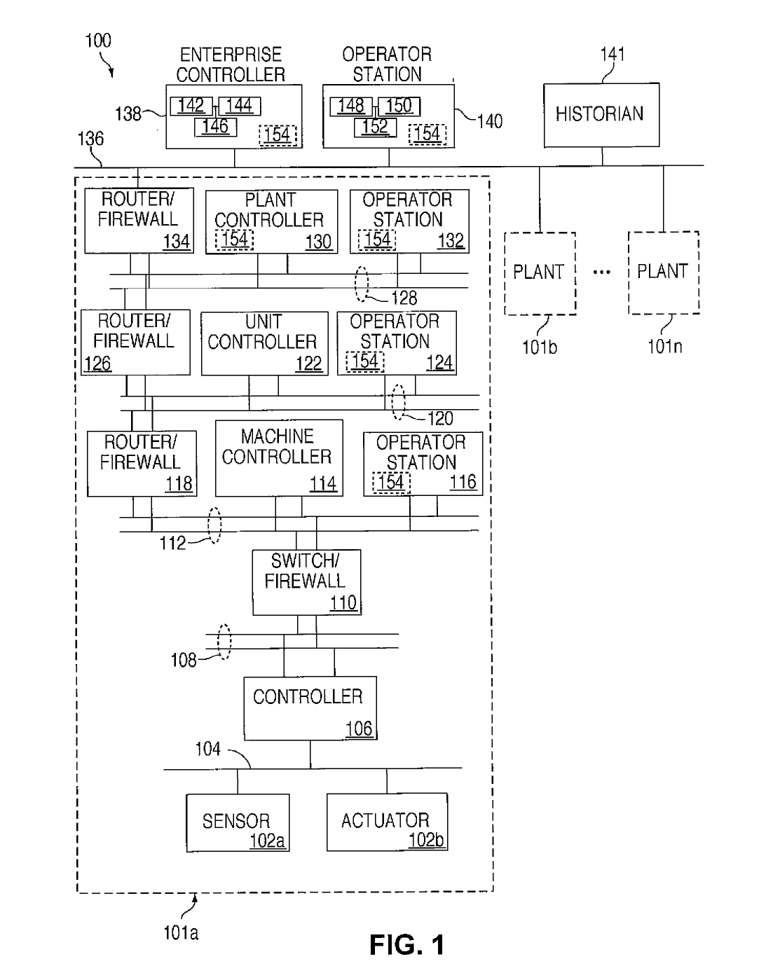

FIGS. 1 through 5, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example process control system 100 according to this disclosure. The embodiment of the process control system 100 shown in FIG. 1 is for illustration only. Other embodiments of the process control system 100 may be used without departing from the scope of this disclosure.

In this example embodiment, the process control system 100 includes various components that facilitate production or processing of at least one product or other material. For instance, the process control system 100 is used here to facilitate control over components in one or multiple plants 101a-101n. Each plant 101a-101n represents one or more processing facilities (or portions thereof), such as one or more manufacturing facilities for producing at least one product or other material. In general, each plant 101a-101n may implement one or more processes and can individually or collectively be referred to as a process system. A process system may generally represent any system or portion thereof configured to process one or more products or other materials in some manner.

In FIG. 1, the process control system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b, such as heaters, motors, or valves, could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any hardware, software, firmware, or combination thereof for interacting with one or more sensors 102a and controlling one or more actuators 102b. Each controller 106 could, for example, represent a multivariable controller, such as a Robust Multivariable Predictive Control Technology (RMPCT) controller or other type of controller implementing advanced process control (APC). As a particular example, each controller 106 could represent a computing device running a MICROSOFT WINDOWS operating system.

Two networks 108 are coupled to the controllers 106. The networks 108 facilitate interaction with the controllers 106, such as by transporting data to and from the controllers 106. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any hardware, software, firmware, or combination thereof for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any hardware, software, firmware, or combination thereof for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any hardware, software, firmware, or combination thereof for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any hardware, software, firmware, or combination thereof for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any hardware, software, firmware, or combination thereof for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any hardware, software, firmware, or combination thereof for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any hardware, software, firmware, or combination thereof for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any hardware, software, firmware, or combination thereof for supporting user access and control of one or more components in the system 100. Each of the operator stations 140 could, for example, represent a computing device running a MICROSOFT WINDOWS operating system.

A historian 141 is also coupled to the network 136 in this example. The historian 141 could represent a component that stores various information about the process control system 100. The historian 141 could, for example, store information used during production scheduling and optimization. The historian 141 represents any suitable component for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers could include one or more processors 142 and one or more memories 144 for storing instructions and data used, generated, or collected by the processor(s) 142. Each of the servers could also include at least one network interface 146, such as one or more Ethernet interfaces. Also, each of the operator stations could include one or more processors 148 and one or more memories 150 for storing instructions and data used, generated, or collected by the processor(s) 148. Each of the operator stations could also include at least one network interface 152, such as one or more Ethernet interfaces.

As described above, different components in the process control system 100 may use different types of models. For example, one or more of the controllers 106, 114, and 122 could implement advanced process control functions using detailed dynamic models. One or more of the controllers 130 and 138 could implement planning and production scheduling functions using aggregate models.

In one aspect of operation, at least one component of the system 100 implements or otherwise provides an integration mechanism that helps to integrate multiple components of the process control system 100. For example, advanced process control components can perform their functions using the detailed dynamic models, and planning and production scheduling components can perform their functions using the aggregate models. The integration mechanism allows different components with distinctly different models to collaborate and optimize together by using “contribution values” and “predicted yields,” which are described below.

The integration mechanism can be implemented as an integration unit 154 in one or more components of the process control system 100. For example, the integration unit 154 could be implemented on the operator station 116, operator station 124, plant-level controller 130, operator station 132, enterprise-level controller 138, or operator station 140. In general, the integration unit 154 could be implemented on any server, real-time workstation, application or execution platform, distributed control system (DCS), real-time controller, or other suitable device or system.

In some embodiments, the integration unit 154 is used to integrate planning and scheduling tools with APC/unit optimization tools. The integration unit 154 could be implemented as a software package executed as a real-time plant-wide optimizer that coordinates productions, handles upsets, compensates for model-versus-actual mismatches, minimizes feed and utility use, captures market opportunities, and maximizes plant profitability in real-time.

As noted above, the integration unit 154 can support the use of contribution values. Each contribution value may be associated with an intermediate product that is used to produce one or more final products (a final product represents a product output by the process system). A contribution value may be computed using that intermediate product's contribution to each final product and each final product's price. The integration unit 154 can also support the use of predicted yields, which represent estimates of the quantity of one or more intermediate or final products to be produced by the process system in a given time period. In an iterative process, the contribution values and the predicted yields can be revised by the integration unit 154 until an optimum point is found. This point may represent the optimal production schedule to be used, while taking into account both constraints and other limitations of the process system and business economics.

Additional details regarding the integration unit 154 and the use of contribution values and predicted yields are described below. The integration unit 154 includes any hardware, software, firmware, or combination thereof supporting the integration of multiple components using an intermediate product's contribution to one or more final products and each final product's price. The integration unit 154 could, for example, represent a computing device having at least one processor, at least one memory, and at least one network interface (note that the processor, memory, and network interface could be the same components in an operator station or controller or different components).

The integration mechanism allows various components in the system 100 to complete their designed functions while achieving dynamic global optimization. Depending on the implementation, benefits of this integration could include:

feed reduction of raw materials entering a process system while meeting production plans;

more economic operation for handling upsets in process units;

more agile response to capture spot market buy/sell opportunities;

reconciled feedback for next-period planning;

ability to re-use planning models (which are often multi-year projects involving millions of dollars);

reduction of total inventory (and thus capital) in the presence of demand fluctuations; and

movement of inventory upstream to make irreversible decisions just in time.

Various ones of these benefits can be obtained in both process industries and discrete manufacturing industries.

Although FIG. 1 illustrates an example process control system 100, various changes may be made to FIG. 1. For example, a control system could include any number of sensors, actuators, controllers, servers, operator stations, networks, and integration units. Also, the makeup and arrangement of the process control system 100 in FIG. 1 is for illustration only. Components could be added, omitted, combined, or placed in any other suitable configuration according to particular needs. Further, particular functions have been described above as being performed by particular components of the system 100. This is for illustration only. In general, process control systems are highly configurable and can be configured in any suitable manner according to particular needs. In addition, FIG. 1 illustrates one operational environment in which an integration unit can be used. This functionality could be used in any other suitable device or system (whether or not related to process control).

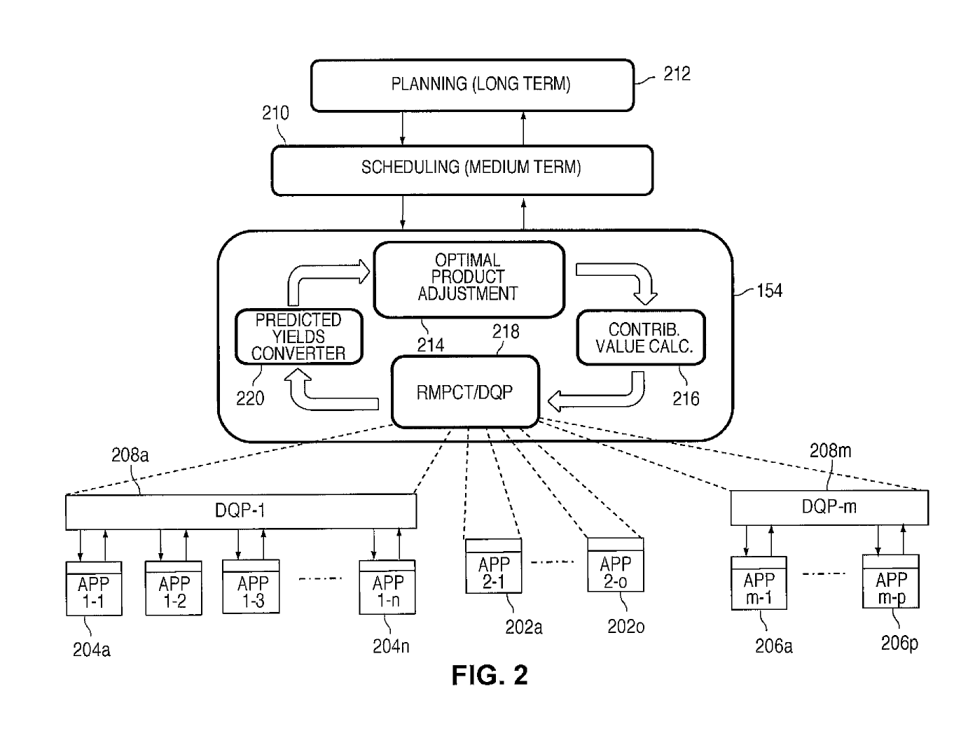

FIG. 2 illustrates an example integration unit 154 according to this disclosure. In particular, FIG. 2 illustrates a connection view of the integration unit 154. The embodiment of the integration unit 154 shown in FIG. 2 is for illustration only. Other embodiments of the integration unit 154 may be used without departing from the scope of this disclosure.

As shown in FIG. 2, various controllers 202a-202o are coupled directly to the integration unit 154. Other controllers 204a-204n, 206a-206p are coupled indirectly to the integration unit 154 through real-time dynamic optimizers 208a-208m. Here, the dynamic optimizers 208a-208m may support distributed quadratic programming and are therefore denoted as “DQP.”

Each of the controllers 202a-202o, 204a-204n, 206a-206p could include any suitable structure for controlling a process or portion thereof. For example, each of the controllers 202a-202o, 204a-204n, 206a-206p could represent an RMPCT controller or other advanced process controller. The RMPCT control technology is described in the following U.S. patents, which are hereby incorporated by reference: U.S. Pat. No. 5,351,184; U.S. Pat. No. 5,561,599; U.S. Pat. No. 5,572,420; U.S. Pat. No. 5,574,638; and U.S. Pat. No. 5,758,047. The controllers 202a-202o, 204a-204n, 206a-206p could, for example, represent the controllers 114 or 122 in FIG. 1.

Each of the dynamic optimizers 208a-208m includes any suitable structure supporting local dynamic optimization of process controllers. The dynamic optimizers 208a-208m could, for example, implement the technology described in the following U.S. patents, which are hereby incorporated by reference: U.S. Pat. No. 6,055,483 and U.S. Pat. No. 6,122,555. The dynamic optimizers 208a-208m could, for example, represent the controllers 122 or 130 in FIG. 1.

In general, the integration unit 154 receives data related to short-term control of one or more processes (or portions thereof) from the controllers 202a-202o, 204a-204n, 206a-206p and dynamic optimizers 208a-208m. The data received by the integration unit 154 from the controllers 202a-202o, 204a-204n, 206a-206p and dynamic optimizers 208a-208m could include the following: measured product yields and measured production inventories.

The integration unit 154 also receives data from a medium-term scheduling application 210 and a long-term planning application 212. The applications 210-212 could, for example, be executed by the plant-level controller 130 and/or the enterprise-level controller 132 in FIG. 1. Scheduling typically involves the planning of production schedules to satisfy a production plan generated during long-term planning. The data received from the applications 210-212 could include the following: production volume targets, quality maximum and minimum targets, allowed deviations from targets, modeled (predicted) product yields, and estimated product prices. This data could be provided in the form of one or more intrinsic first-principles models.

The integration unit 154 operates to iteratively identify (i) contribution values based on the data from the higher-level applications and prior iterations and (ii) predicted yields based on the contribution values and the data from the lower-level controllers. Once an optimal solution (such as an optimal schedule) is found, the integration unit 154 provides various data to the other components shown in FIG. 2. The data provided by the integration unit 154 to the controllers 202a-202o, 204a-204n, 206a-206p and dynamic optimizers 208a-208m could include the following: contribution values for product value optimizations. The data provided to the applications 210-212 could include the following: reconciled actual/predicted product yields, incremental re-planning profit, predicted production inventories, and desirable carry-overs from one planning period to a subsequent planning period.

The components 202a-202o, 204a-204n, 206a-206p, 208a-208m, 210, 212 typically operate using different models. The integration unit 154 can help to integrate the data from these components to support plant-wide (or even enterprise-wide) optimization. The integration unit 154 does this by iteratively calculating the contribution values and predicted yields. The contribution values are determined for various intermediate products used to produce one or more final products. The contribution values can then be used to estimate predicted yields of the intermediate and final products. This process can repeat iteratively until an optimal or near-optimal global solution is found. The optimal or near-optimal global solution can be made available to the components 202a-202o, 204a-204n, 206a-206p, 208a-208m and planning or scheduling updates can be made available to the components 210-212 in suitable form for use in their respective operations.

In particular embodiments, the applications 210-212 operate by performing steady-state formulation of planning and scheduling without data reconciliation, and they involve larger scopes and longer time horizons with material aggregation. In contrast, the controllers 202a-202o, 204a-204n, 206a-206p and dynamic optimizers 208a-208m operate by performing dynamic formulation using feedback control, and they involve smaller scopes and shorter time horizons and are more flexible. The integration unit 154 helps to integrate the planning and scheduling operations performed by the applications 210-212 with the control of a process performed by the controllers 202a-202o, 204a-204n, 206a-206p and dynamic optimizers 208a-208m.

Integrating these different functions is not a trivial task. These components often have different purposes with different decision variables. Planning may be directed at obtaining overall profitability and material/energy balance, such as by selecting feed and plant configurations. Scheduling may be primarily directed at generating feasible production plans (possibly including parts of planning, often at a more detailed level). Control may be used for ensuring safe, stable operation of a process unit (possibly with local economic optimization).

These different components also often have different levels of model abstraction in order to achieve their different purposes and design requirements, one of the important requirements being completing the solution computation in an acceptable amount of time. Planning and scheduling typically use aggregate models, omitting many operating constraints. Control often needs to use detailed dynamic models, including important operating constraints, in order to control or satisfy these constraints. Planning and scheduling also typically use both physical and logical units (e.g., for “what-if” analysis), while control typically uses only physical units (typically with greater details).

Model mismatch can therefore exist between these components in terms of scope and granularity. Scope mismatch often exists because the planning scope is typically the largest and covers a complete plant or several plants. The other functions' scopes are routinely smaller and less expansive. Granularity mismatch often exists because one function's model may contain the details that other functions do not. For instance, planning models may contain blending rules that APC controllers are not aware of, and APC models may contain detailed operational constraints not included in planning or scheduling models. Not only that, these different functions often have different time horizons for either steady-state or dynamic models. Planning and scheduling typically use longer horizons (such as days, weeks, or months) in steady-state models, while control time horizons typically vary from several minutes to several hours.

Because of this, these models typically cannot be easily combined into one model for global optimization. Even if they could be combined, it would not be easy to use the combined model for three different purposes (planning, scheduling, and control). In FIG. 2, the integration unit 154 can support the use of these models as a hybrid collection for global, real-time optimization.

Without the use of the integration unit 154, two common challenges would normally exist between planning/scheduling and execution (control). During the planning/scheduling stages, many operational constraints and asset availability cannot be known in advance, so it is possible to develop an infeasible plan, an overly conservative plan, or both (in different areas, time periods, or metrics). Also, during the execution stages, global planning objectives may not be easily discernible by or deemed feasible to the local units. Not all units may be acting in concert or could be competing against each other for globally-constrained resources. This can result in the loss of profitability. However, the integration unit 154 supports the integration of both human operations (such as sales, planning, operations, maintenance, and distribution) with software or other automated operations (such as planning, scheduling, and advanced control). This can result in significant economic benefits. It can also support real-time continuous planning to obtain economically-optimal real-time responses to unexpected events. It can further provide for better agility to capture spot market opportunities, support multi-site capacity sharing for jointly serving a market, and obtain inventory reductions (such as a 20% reduction).

In FIG. 2, the integration unit 154 allows the other components to continue using their existing models (even though those models are distinctly different). The integration unit 154 operates as an agent to pass operating constraints from the lower-level controllers to the planning and scheduling applications via the predicted yields. The integration unit 154 also acts as an agent to disseminate global optimality conditions from the planning and scheduling applications to the lower-level controllers via the contribution values. The integration unit 154 supports the iterative scheme to find a global optimum between the two.

As noted above, the integration unit 154 operates by iteratively calculating contribution values for intermediate products and updating predicted yields for intermediate and final products. In general, a yield may be related to an intermediate or final product being produced. A yield could also represent energy consumption or other quantity that is modeled and managed by an optimization tool.

In the following discussion, the integration unit 154 is described as using actual and predicted yields for one or more products and/or other quantities. The actual yield (or quantity) of an intermediate or final product may differ from the expected yield defined in a model or specification for various reasons. These reasons can include minor model-plant structural mismatches, the use of long-term averages as the model yields in planning, unplanned or unexpected upsets or other events, unmodeled process constraints (such as flooding or run-down temperature), and feed tank heels (such as 15-20%) and feed mixing issues. Since product specifications are typically tightly controlled in each unit (while yields are typically not), mismatches tend to show up more in unit yields than in specifications. Note that a “specification mismatch” can often be converted into a yield mismatch, such as when an off-specification intermediate product is made and blended off or re-processed.

In this example, the iterative operations performed by the integration unit 154 include an optimal product adjustment module 214. The optimal product adjustment module 214 typically receives, from the applications 210-212, a complete planning/scheduling model (or subset thereof) and a profitability objective function. The optimal product adjustment module 214 can also receive predicted yields from a prior iteration, and it can use the predicted yields to update the previously-received model. The optimal product adjustment module 214 can then determine if and when a target quantity of one or more products should be changed, such as in response to changes in an actual product yield for one of the products.

In particular embodiments, the optimal product adjustment module 214 can operate as follows. The actual yield of a product during part of a planned period can be measured (either online or in a laboratory). For the remainder of the planned period, an optimal product adjustment problem can be defined as:

$$\begin{matrix}{min}_{Δ x} ( {c}_{a}^{t} \cdot Δ x ) \cdot ( T - t ) & ( 1 ) \\ s \cdot b \cdot \underline{{b}_{a}} \leq A ( {y}_{a} ) \cdot ( {x}^{*} + Δ x ) \leq \overline{{b}_{a}} & ( 2 ) \\ \underline{Δ l} \leq Δ x \leq \overline{Δ l} & ( 3 ) \\ {c}_{0}^{t} \cdot ( {x}^{*} + Δ x ) > {J}^{*} , or {c}_{0}^{t} \cdot Δ x > 0. & ( 4 )\end{matrix}$$

In Equation (3), Δlᵢ can equal zero for non-participation variables. According to Equation (4), a target yield for one or more products can be adjusted if it increases plant profitability, where J* is the original planned profitability. Note also that Equation (4) is optional and its inclusion can be determined case-by-case based on the application needs. Solving this optimal production adjustment problem allows the integration unit 154 to obtain new optimal production adjustments based on real-time yield feedback.

After that, a contribution value calculator module 216 operates. The calculator module 216 can calculate the contributing quantity in percentage of an intermediate product to each final product being produced. There are a number of options or variations for calculating the contribution value of an intermediate product. In some embodiments, an intermediate product's contribution value is calculated as:

$${\sum }_{i = 1}^{n} {Contribution}_{i} ( \% ) \times {ProductPrice}_{i} - {FurtherProcessingCost}_{i} . \qquad ( 5 )$$

Here, n represents the number of final products that can be produced using an intermediate product. Also, Contributionᵢ represents the percentage of the intermediate product that is dedicated to producing the i^{th} final product, and ProductPriceᵢ represents the expected or the current market price for the i^{th} final product. In addition, FurtherProcessingCostᵢ represents the additional processing cost needed to produce the i^{th} final product (which may optionally be omitted or set to zero).

As a particular example, assume that an intermediate product in an oil refinery can be used to produce three products, namely gasoline, jet fuel, and diesel fuel. Also assume that the current (i.e., adjusted) plan is to use 30% of the intermediate product to produce gasoline, 35% of the intermediate product to produce jet fuel, and 35% of the intermediate product to produce diesel fuel. The intermediate product's contribution value could therefore equal 30% of the gasoline's price plus 35% of the jet fuel's price plus 35% of the diesel fuel's price.

In other embodiments, an intermediate product's contribution value is calculated as:

$${\sum }_{i = 1}^{n} {Contribution}_{i} ( \% ) \times {AdjustedProductPrice}_{i} - {FurtherProcessingCost}_{i} . \qquad ( 6 )$$

Here, the product price for the i^{th} final product can be adjusted to correct for various over- and under-production scenarios or other situations. For instance, when the projected production of the i^{th} final product exceeds its plan, the final product's price can be decreased to account for storage costs and future order risks. When the projected production of the i^{th} final product is below its plan, the final product's price can be increased if there is a penalty for missing an order deadline.

Note that various adjustments can also be made to the contribution values by the calculator module 216. For example, when storage is available, a commonly-valuable intermediate product could be stored and saved for the next planning period (rather than reducing its contribution value in the current period). As another example, if an excess intermediate product can be sold on a spot market, a higher contribution value could be assigned to the intermediate product. Further, note that contribution values can be tied together for a current planning period and for the next planning period, which can help to reduce undesirable diminishing horizon effects at the current period's end.

An RMPCT/DQP module 218 may then operate using the identified contribution values. The RMPCT/DQP module 218 can receive actual process measurements, including yields or inventory levels of intermediate and final products, from the lower-level controllers. The RMPCT/DQP module 218 can also predict future yields of the intermediate and final products based on the received contribution values and product specifications. The RMPCT/DQP module 218 could replicate the calculations performed by the lower-level controllers, or the RMPCT/DQP module 218 could send the contribution values to the lower-level controllers and receive predicted yields from the lower-level controllers. The RMPCT/DQP module 218 used here could execute standard calculations performed by RMPCT or DQP technology to determine how best to optimize production of the intermediate or final products, where the predicted yields are based on the contribution values of the various intermediate products.

Various techniques can be used to identify the measured yields and then predicted yields for a product. For example, measured yields can be based on various time averages, filtering, or laboratory updating technologies. Predicted yields can use the measured yield as a base and then further reflect the effects of both model-plant mismatch and production capacity change under current operating constraints. An incremental yield prediction (over a current measured yield) can be determined using an APC control model and the contribution values, which can therefore incorporate current operating constraints. Alternatively, other mechanisms such as yield curves can be used that do not incorporate current operating constraints.

The predicted yield of a product output by the RMPCT/DQP module 218 could represent a sum of the actual measured yield of that product, plus any incremental change in yield determined by the RMPCT/DQP module 218. Optionally, a predicted yield conversion module 220 can be used to change the format of each predicted yield so that the predicted yield can be fed back to the optimal product adjustment module 214 in a compatible model data arrangement.

At this point, the process can be repeated, where the predicted yields are used by the optimal product adjustment module 214. The modules 214-220 within the integration unit 154 can be iteratively executed or otherwise operated until a globally optimal or near-optimal solution is obtained. When an acceptable solution is found, the integration unit 154 can provide the solution to the lower-level controllers for implementation. The integration unit 154 can also provide planning or scheduling updates to the higher-level applications.

In this example embodiment, the contribution values function as a proxy for business economics used by the higher-level planning or scheduling components. By breaking down the business economics into contribution values, the lower-level controllers can perform product value optimizations that deliver a real-time global optimality based on the business economics. Similarly, the predicted yields function as a proxy for operating constraints enforced by the lower-level controllers. By providing predicted yields that satisfy the operating constraints to the higher-level applications, the resultant adjusted optimized production can always be feasible. In other words, infeasible (or overly-conservative) plans or schedules can be identified and re-optimized prior to implementing those plans or schedules.

The use of contribution values may be advantageous in various circumstances. As a particular example, if advanced process control, a human operator, or another other tool unilaterally increases the yield of an ostensibly valuable intermediate product and the optimal product adjustment module 214 cannot find a way to use the intermediate product for improving profitability, the contribution value of that intermediate product may generally go down. As another particular example, if an upset or disturbance adversely decreases the yield of a valuable intermediate product, the adjusted product price for the impacted final products may increase or stay the same, causing a rebalance of contribution values and a rebalance of various intermediate products' productions to mitigate the profitability impact to a minimum. Also, the use of the RMPCT/DQP calculations can help to take into account predicted yields that reflect current operating constraints, which a planning or scheduling model may omit. Further, the integration unit 154 could obtain a real-time, global optimum with a collection of hybrid models using a decentralized solution.

Various benefits can be obtained using this approach. For example, this approach enables unit production coordination in the presence of disturbances, upsets, and unplanned events. Unit production coordination can also take into account situations where APC improves the yield of more valuable products and, if an off-specification product is made in a unit, coordinate other units to blend it off or otherwise minimize its monetary impact.

As another benefit, the integration unit 154 supports a feedback mechanism for planning model updates, which can help to provide more accurate planning. For example, the feedback mechanism can be used to provide better yield profiles (or true production capability estimates) to the planning model. This can be used to gradually reduce any mismatch between the planning model and the actual production plant.

Yet another benefit includes the support of “what-if” analyses. For example, the integration unit 154 can be used to analyze the feasibility (or the optimality) of a new set of schedules or plans, to evaluate make-versus-buy decisions if applicable, and to build up inventory for the next planning period, event, or disturbance. A make-versus-buy analysis can be used to determine whether an intermediate or final product should be manufactured or bought from someone else. For example, this type of analysis could be triggered when the estimated cost of manufacturing a final product exceeds the spot market price for the same product, meaning it may be cheaper to buy the final product for a customer than to manufacture the final product for the customer.

Moreover, this type of integration may be beneficial in various industries, such as just-in-time manufacturing. For example, the integration unit 154 can be used to help reduce the total inventory (and thus capital) in the presence of demand fluctuations. It can also move inventory as upstream as possible (if so desired) to make irreversible decisions just in time to satisfy the demand.

In addition, the integration of APC control and optimization with planning and scheduling can handle favorable mismatches in yield. An APC can typically increase high-value intermediate product yields (such as by 5-10%) using improved control and operation stability. However, a certain percentage of these benefits may be lost if and when a planning model cannot be updated to incorporate the improved yields. Worse yet, the improved yields often show up as inventory “upsets” of the intermediate or final products. Here, the integration unit 154 can provide expanded flexibility in real-time business optimization. For example, the integration unit 154 can be used to minimize feed use while meeting original production plans. The integration unit 154 can also help to use spare capacity to produce sellable products on spot markets.

Each module 214-220 of the integration unit 154 could be implemented using any suitable hardware, software, firmware, or combination thereof. For example, the modules 214-220 could represent software code forming at least part of a software package executed by a controller, operator station, or other computing device in a process control system.

Although FIG. 2 illustrates an example integration unit 154, various changes may be made to FIG. 2. For example, the integration unit 154 could receive inputs from any number of lower-level controllers or other components and from any number of higher-level applications or other components. The integration unit 154 can also provide outputs to any number of lower-level controllers or other components and to any number of higher-level applications or other components.

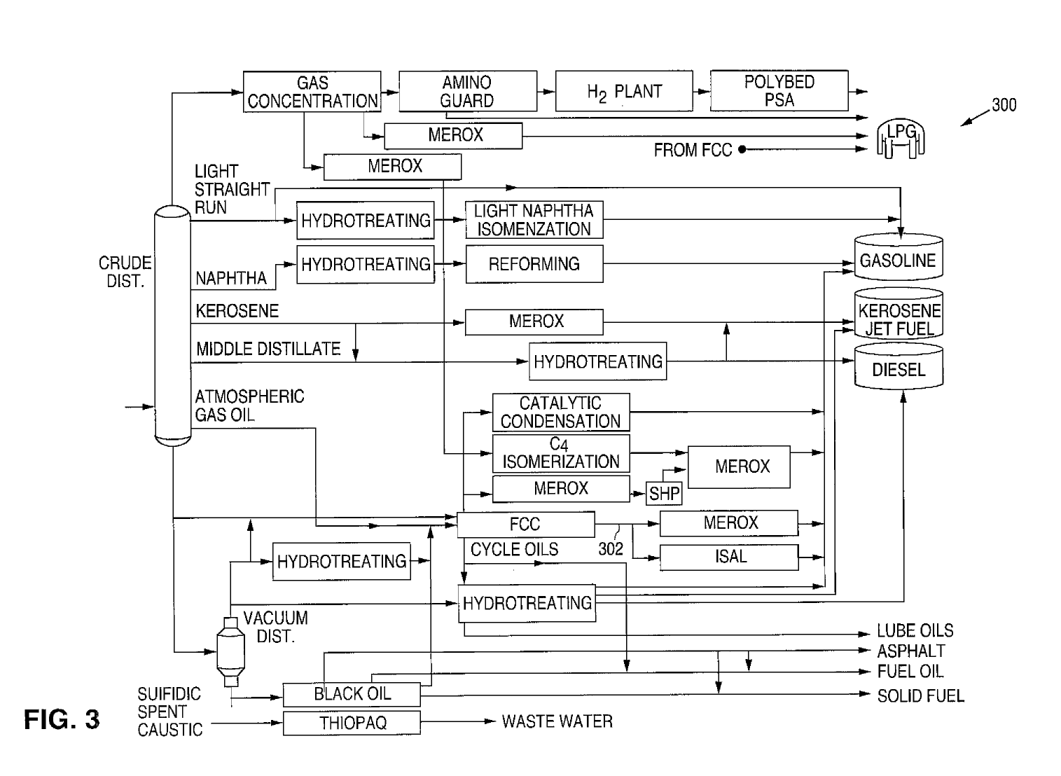

FIGS. 3 and 4 illustrate an example use of an integration unit 154 according to this disclosure. The example uses of the integration unit 154 shown in FIGS. 3 and 4 are for illustration only. The integration unit 154 could be used in any other suitable manner without departing from the scope of this disclosure.

FIG. 3 illustrates an example representation of an oil refinery 300. In this example, the refinery 300 receives an input raw material (crude oil) on the left side of FIG. 3 at a crude distillation tower. Various outputs of the distillation tower are processed by other units to produce eight different output streams on the right side of FIG. 3. The output streams include liquefied petroleum gas (LPG), gasoline, jet fuel, diesel fuel, lube oils, asphalt, fuel oil, and solid fuel.

In some embodiments, one goal of a process control system controlling the refinery 300 is to maximize profitability (defined as product sales minus feed costs minus operating costs) by controlling feed selection, blend pool selection, plant operation configurations, and charge rate for each unit or specification. This goal is subject to various conditions, such as market opportunities (like long-term orders and spot markets), material balance (like H₂ and various forms of C₄), and energy balance (like steam and power).

In this example, there are numerous intermediate product streams formed within the refinery 300. One example is the intermediate stream 302 from a fluid catalytic cracking (FCC) unit. This intermediate stream 302 can be used to produce multiple final products, namely gasoline, jet fuel, diesel and LPG. If the integration unit 154 shown in FIG. 2 is used in conjunction with the refinery 300, the integration unit 154 can generate contribution values related to the intermediate stream 302.

The integration unit 154 can then use those contribution values to predict the yields of the various final products.

The iterative process described above can be repeated numerous times until an optimal solution is found related to the planned yields of the final products to be produced.

In particular embodiments, the integration unit 154 can operate to maximize profitability while maintaining material balance and energy balance.

FIG. 4 illustrates how just in time or produce to order systems (such as the refinery 300) can use the integration unit 154. In this example, one of the final products i produced by the refinery 300 is stored in a tank 400. During operation, the product i is stored in the tank 400 at a “projected flow rate” of fᵢ. Also, orders remove the product i from the tank 400 at an “order flow rate” of oᵢ. The projected inventory for the product i can be determined by taking the time-integral of (fᵢ-oᵢ).

In these embodiments, the AdjustedProductPriceᵢ of the product i can be adjusted based on the high and low inventory projections for that product. Moreover, if an operator attempts to implement an infeasible plan, the determined inventory of the product i may be inadequate to meet the plan. During the iterative process, the higher-level applications 210-212 can be informed that only part of the plan is feasible. At this point, the operator can take other actions (such as attempting to schedule production using a different plant) to manufacture the remaining portion of the plan.

Although FIGS. 3 and 4 illustrate example uses of an integration unit 154, various changes may be made to FIGS. 3 and 4. For example, the integration unit 154 is not limited to use with oil refineries or just in time manufacturing systems. Rather, the integration unit 154 can be used with any suitable process industry or discrete manufacturing industry.

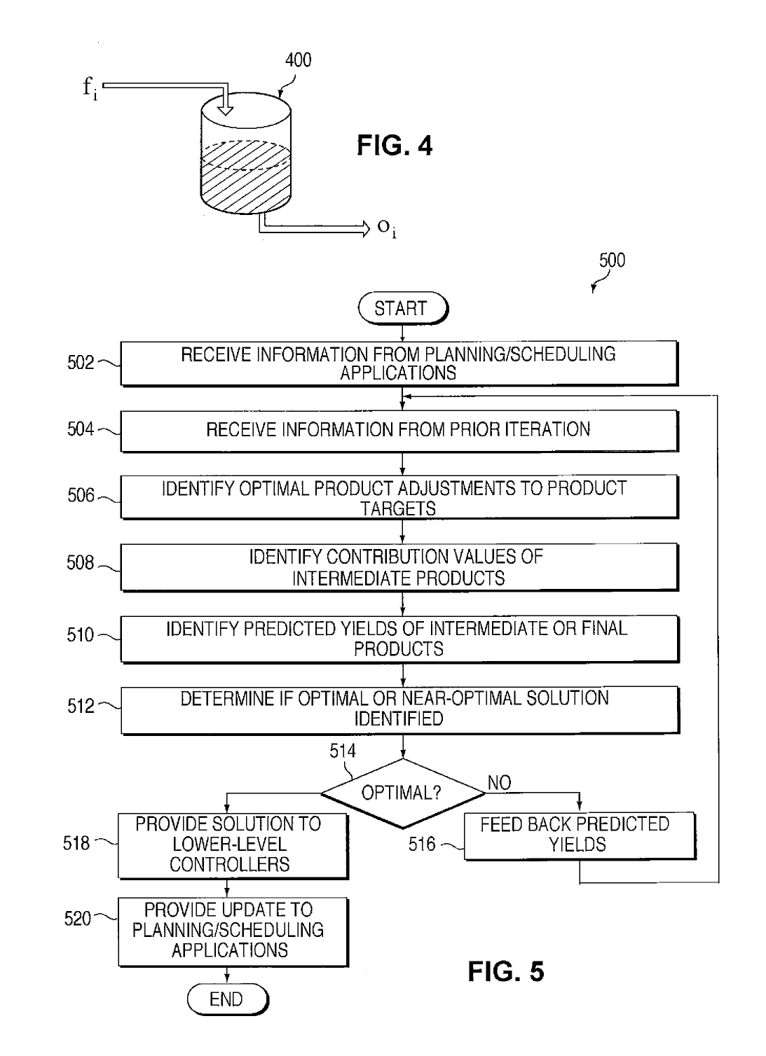

FIG. 5 illustrates an example method 500 for integrating planning, scheduling, and control for enterprise optimization according to this disclosure. The embodiment of the method 500 shown in FIG. 5 is for illustration only. Other embodiments of the method 500 could be used without departing from the scope of this disclosure. For ease of explanation, the method 500 is described with respect to the integration unit 154, although the method 500 could be performed by any other device or system.

As shown in FIG. 5, the integration unit 154 receives information from a planning application or a scheduling application at step 502. This could include, for example, the integration unit 154 receiving part or all of a planning/scheduling model and a profitability objective function. The integration unit 154 receives information from a prior iteration (if any) at step 504. This could include, for example, the integration unit 154 receiving one or more predicted yields and updating the planning/scheduling model based on those yields.

The integration unit 154 identifies one or more optimal product adjustments to the product targets at step 506. This could include, for example, the optimal product adjustment module 214 solving an optimal product adjustment problem, such as the one defined in Equations (1)-(4). The integration unit 154 identifies one or more contribution values for one or more intermediate products at step 508. This could include, for example, the contribution value calculator module 216 calculating the contribution values as shown in Equation (5) or (6). The integration unit 154 identifies one or more predicted yields for one or more intermediate or final products at step 510. This could include, for example, the RMPCT/DQP module 218 using measured yields from one or more lower-level controllers and RMPCT/DQP calculations to predict future yields.

A determination is made whether the identified solution (the predicted production targets) is an optimal or near-optimal solution at step 512. Any suitable criteria could be used to determine when an acceptable solution is obtained. For example, the integration unit 154 could determine whether all production adjustments and/or yield changes for each product from one iteration to the next are less than one or more suitable thresholds.

If the solution is not optimal or near-optimal at step 514, the one or more predicted yields are fed back at step 516, and the steps 504-514 are repeated during an additional iteration. Step 516 could optionally include the conversion module 220 changing the format or otherwise preparing the one or more predicted yields to be provided to the optimal product adjustment module 214 in the proper form.

If the solution is optimal or near-optimal at step 514, the solution is provided to the one or more lower-level controllers at step 518, and any planning or scheduling updates are provided to the planning application or scheduling application at step 520. In this way, the lower-level controllers can actually implement the solution to produce the intermediate and final products according to the solution, which can help to ensure that the lower-level controllers support the business economics of the higher-level applications. Also, the planning application or scheduling application can see what is actually being implemented, allowing the operating constraints of the lower-level controllers to be passed to the planning and scheduling applications.

Although FIG. 5 illustrates an example method 500 for integrating planning, scheduling, and control for enterprise optimization, various changes may be made to FIG. 5. For example, while shown as a series of steps, various steps in FIG. 5 could overlap, occur in parallel, occur in a different order, or occur multiple times.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving first input data from one or more first process control system components;
receiving second input data from one or more second process control system components; and
performing an iterative process that includes:
identifying one or more adjustments to at least one target quantity using the first input data, each target quantity associated with at least one intermediate or final product to be produced;
identifying one or more contribution values using the one or more adjustments, each contribution value based on an intermediate product's contribution to each of multiple final products; and
identifying one or more estimated product yields using the one or more contribution values and the second input data, each estimated product yield associated with an expected quantity of one of the intermediate and final products to be produced.

2. The method of claim 1, wherein:
the first input data is received from at least one of:
a planning application and a scheduling application; and
the second input data is received from at least one process controller controlling at least a portion of an industrial process.

3. The method of claim 1, wherein:
the one or more first process control system components use one or more first models having fewer operating constraints and a longer time horizon; and
the one or more second process control system components use one or more second models having more operating constraints and a shorter time horizon.

4. The method of claim 1, wherein:
performing the iterative process comprises performing multiple iterations of the process; and
identifying the one or more adjustments to the at least one target quantity comprises using the first input data and one or more prior estimated product yields identified during a previous iteration of the process.

5. The method of claim 1, wherein identifying the one or more contribution values comprises summing multiple values, each value based on a multiplication product of the intermediate product's contribution percentage to one of the final products and that final product's price.

6. The method of claim 5, wherein each final product's price is adjustable based on high and low inventory projections for that final product.

7. The method of claim 1, wherein:
performing the iterative process comprises performing multiple iterations of the process; and
the iterative process stops when changes between the one or more adjustments or the estimated product yields from one iteration to the next iteration are less than a threshold amount.

8. The method of claim 1, further comprising, when the iterative process stops:
providing the one or more estimated product yields to the one or more first process control system components; and
providing the one or more contribution values to the one or more second process control system components.

9. The method of claim 1, wherein:
the one or more estimated product yields act as a proxy to provide information related to operating constraints associated with the one or more second process control system components to the one or more first process control system components; and
the one or more contribution values act as a proxy to provide information related to business economics associated with the one or more first process control system components to the one or more second process control system components.

10. An apparatus comprising:
at least one interface configured to receive:
first input data from one or more first process control system components; and
second input data from one or more second process control system components; and
at least one processing device configured to perform an iterative process that includes:
identifying one or more adjustments to at least one target quantity using the first input data, each target quantity associated with at least one intermediate or final product to be produced;
identifying one or more contribution values using the one or more adjustments, each contribution value based on an intermediate product's contribution to each of multiple final products; and
identifying one or more estimated product yields using the one or more contribution values and the second input data, each estimated product yield associated with an expected quantity of one of the intermediate and final products to be produced.

11. The apparatus of claim 10, wherein the at least one interface is configured to:
receive the first input data from at least one of: a planning application and a scheduling application; and
receive the second input data from at least one process controller configured to control at least a portion of an industrial process.

12. The apparatus of claim 10, wherein:
the at least one processing device is configured to perform the iterative process by performing multiple iterations of the process; and
the at least one processing device is configured to identify the one or more adjustments to the at least one target quantity by using the first input and one or more prior estimated product yields identified during a previous iteration of the process.

13. The apparatus of claim 10, wherein the at least one processing device is configured to identify the one or more contribution values by summing multiple values, each value based on a multiplication product of the intermediate product's contribution percentage to one of the final products and that final product's price.

14. The apparatus of claim 10, wherein:
the at least one processing device is configured to perform the iterative process by performing multiple iterations of the process; and
the at least one processing device is further configured to stop the iterative process when changes between the one or more adjustments or the estimated product yields from one iteration to the next iteration are less than a threshold amount.

15. The apparatus of claim 10, wherein the at least one processing device is further configured to, when the iterative process stops:
provide the one or more estimated product yields to the one or more first process control system components via the at least one interface; and
provide the one or more contribution values to the one or more second process control system components via the at least one interface.

16. The apparatus of claim 10, wherein the at least one processing device is configured to operate such that:
the one or more estimated product yields act as a proxy to provide information related to operating constraints associated with the one or more second process control system components to the one or more first process control system components; and
the one or more contribution values act as a proxy to provide information related to business economics associated with the one or more first process control system components to the one or more second process control system components.

17. A computer readable medium embodying a computer program, the computer program comprising computer readable program code for:
receiving first input data from one or more first process control system components;
receiving second input data from one or more second process control system components; and
performing an iterative process that includes:
identifying one or more adjustments to at least one target quantity using the first input data, each target quantity associated with at least one intermediate or final product to be produced;
identifying one or more contribution values using the one or more adjustments, each contribution value based on an intermediate product's contribution to each of multiple final products; and
identifying one or more estimated product yields using the one or more contribution values and the second input data, each estimated product yield associated with an expected quantity of one of the intermediate and final products to be produced.

18. The computer program of claim 17, wherein:
the computer readable program code for performing the iterative process comprises computer readable program code for performing multiple iterations of the process; and
the computer readable program code for identifying the one or more adjustments to the at least one target quantity comprises computer readable program code for using the first input data and one or more prior estimated product yields identified during a previous iteration of the process.

19. The computer program of claim 17, wherein the computer readable program code for identifying the one or more contribution values comprises computer readable program code for summing multiple values, each value based on a multiplication product of the intermediate product's contribution percentage to one of the final products and that final product's price.

20. The computer program of claim 17, further comprising:
computer readable program code for providing the one or more estimated product yields to the one or more first process control system components; and
computer readable program code for providing the one or more contribution values to the one or more second process control system components.
